(19) United States
(12) Patent Application Publication
(10) Pub. No.: US 2024/0005894 A1
(43) Pub. Date: Jan. 4, 2024

(54) DUAL HI-HAT SINGLE PEDAL

(71) Applicant: Wesley Mayo, Merritt Island, FL (US)

(72) Inventor: Wesley Mayo, Merritt Island, FL (US)

(21) Appl. No.: 18/142,058

(22) Filed: May 2, 2023

Related U.S. Application Data
(60) Provisional application No. 63/358,108, filed on Jul. 2, 2022.

(51) Int. Cl. G10D 13/065; G10D 13/11

(52) U.S. Cl. CPC G10D 13/065; G10D 13/11

(57) ABSTRACT

The invention is a foot pedal that has a forward pedal that is operated by the drummer's ball of their foot and a second pedal that is operated by the hell of the drummer's foot. This arrangement allows a drummer to operate two separate hi-hat cymbals using only one foot.

### CROSS-REFERENCE TO RELATED APPLICATIONS

This application claims the benefit of U.S. Provisional Patent Application No. 63/358,108, filed on Jul. 2, 2022 entitled DUAL HI-HAT SINGLE PEDAL, which is incorporated by reference herein in its entirety.”

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### Field of the Invention

The invention relates to the field of a dual hi-hat cymbal device. Musical notes have been created using many forms of instruments and devices. Percussion instruments, i.e., those that generate sound by being beaten, rattled, and/or vibrated, are sometimes considered to be the oldest type of musical instrument. There are many types of percussion instruments; the drum is considered a classic example of a percussive instrument.

A drum may be sounded by striking some portion of the drum with the hand. Some drums may also generate different tonal sounds when struck with a beater, mallet, or stick. Some musical genres utilize various different percussive sounds and tones to evoke different feelings in the listener; as such, different types of beaters, as well as the drummer's hand, may be used to produce various tones from a given drum.

Depending on the type of music being played, different tonal qualities of an instrument may be more desirable. For example, a flamenco style piece may emphasize different tonalities and tonal relationships between notes than a jazz style of music. Some musical pieces employ different consonance (relaxation and/or harmonization) and dissonance (tension and/or conflict) between the tonic (the central note of a chord or piece of music) and the other notes in a musical composition. As such, different beaters, or hand-beater combinations, may be desirable for some drums.

Some drums sets use cymbals that use foot-operated devices, sometimes referred to as “cymbal pedals” or “cymbal pedal assemblies” to operate and/or control a cymbal that raises and drops another cymbal so that one cymbal strikes another cymbal. The pedal may be operated in conjunction with the drummer's hand, such that the drum can be played with the hand to create one tone and the drum pedal activates the cymbal pair to create another tone, without the drummer having to use their hand to strike the cymbal. Such an arrangement allows for faster playing as well as allowing the drummer to play more complicated/technical pieces. There are a number of musical arrangements where the drummer needs a second hi-hat cymbal and that presents difficulties for the drummer because they must activate the first and the second hi-hat cymbal with separate foot pedals. Two-foot cymbal pedals require the drummer to move their foot from the first hi-hat pedal to the second hi-hat pedal to activate the second hi-hat cymbal. This results in the drummer not being able to utilize both hi-hat cymbals in relatively synchronous method because the drummer must physically move their foot from the first pedal to the second pedal. This action can cause a non-synchronous sound or make the playing of the musical arrangement difficult for the drummer.

Thus, there is a need in the art for a cymbal activation device that can operate two hi-hat cymbals using one foot.

### Description of Related Art

Currently the state of the art includes various hi-hat cymbal configurations with a pedal to operate the cymbal. However, many times a musical piece requires the use of two or more hi-hat cymbals, and this presents the drummer with many difficulties. The drummer is forced to use two hi-hat cymbals and either uses his drum petal foot to activate the second hi-hat cymbal or position the second hi-hat cymbal so that the drummer can activate the first and second with the second foot.

### SUMMARY OF THE INVENTION

In the first implementation of the invention there is a foot pedal that has a forward pedal that is operated by the drummer's ball of their foot and a second pedal that is operated by the hell of the drummer's foot. This arrangement allows a drummer to operate two separate hi-hat cymbals using only one foot. The

### BRIEF DESCRIPTION OF DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is. a view of the prior art consisting of a drum set with one hi-hat cymbals.

FIG. 2 is a view of the prior art consisting of a drum set with two hi-hat cymbals.

FIG. 3 is a view of the prior art with a single pedal hi-hat cymbal.

FIG. 4 is a view of a dual pedal hi-hat of the instant invention with a first cymbal and a second cymbal operated by the dual pedal hi-hat actuator.

FIG. 5 is an elevation view of a drum set with a dual pedal hi-hat actuator of the instant invention.

FIG. 6A is a side view of the dual pedal hi-hat actuator petal base plate.

FIG. 6B is an end view of the dual pedal hi-hat actuator petal base plate.

FIG. 6C is a plan view of the dual pedal hi-hat actuator petal base plate.

FIG. 7A is a top view of toe pedal of the instant invention;

FIG. 7B is a side view of toe pedal of the instant invention;

FIG. 7C is a bottom view of toe pedal of the instant invention;

FIG. 8 is a plan view of the instant invention;

FIG. 9A is a top view of pedal of the instant invention;

FIG. 9B is a side view of heal pedal of the instant invention;

FIG. 9C is a bottom view of heal pedal of the instant invention;

### DETAILED DESCRIPTION OF THE INVENTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms hi-hat as used in the specification is meant to mean a dual cymbal device that can be operated by a foot pedal or struck with the drumstick or other percussion device.

Currently there is no other dual hi-hat single pedal in existence. The pedal of the instant invention is designed in a hinge manner, where the toe pedal will operate the front hi-hat from pressing downwards with the ball of the foot. The second hi-hat is operated by the heel of the foot. these 2 pedals are joined together through a basic hinge mechanism that is close to the center of the 2 operational hi-hats. As used the dual hi-hat single pedal is part of a percussionist's musical hardware.

The Pedal gives a Percussionist the ability to use 2 hi-hats independently at any time without the cumbersome problems that are associated with the adding of a second complete hi-hat.

A hi-hat pedal (the hi-hat is a percussion instrument) has 2 cymbals; they lie horizontal one on top of the other. a metal rod going up through both, the top cymbal is connected to this rod that goes down through a shaft that places the rod connected to a foot pedal that with the help of an internal spring in the mechanism that naturally will keep the hi-hat in the upward motion. the foot pedal is to bring the rod downward causing the top cymbal to crash into the bottom cymbal.) thus making a sound. The pedal that this patent represents has the design for the ability to have a standard hi-hat connected to the front of the pedal and also to have a second hi-hat through the remote style connected to the rear left side of the pedal.

The pedal of the instant invention is constructed in a manner. The percussionist can use it by simply using the ball or heel of their left foot they can use either hi-hat cymbals together or independently. Adding to the percussionist more and different designs that gives more style to play with. The instant invention gives the percussionist a more efficient way and less cumbersome way to add a second hi-hat into the mix of a song. It also gives more choices to the percussionist on the type or style of how he or she would like to play.

The design of the instant invention is simple. The instant invention provides the ability to use one pedal, one that is similar to the stand pedal that is already in use. The major difference is the added hi-hat. The percussionist does not need to be concerned with the movement of the right foot from the kick pedal to the extra hi-hat. Therefore, using the instant invention creates a smooth transition when the song requires a second hi-hat cymbal. This also eliminates the need for the percussionist to use the other foot which is operating the kick pedal and the other foot operates both hi-hat cymbals using the pedal of the instant invention.

The dual hi-hat single pedal can be set up in a manner that the front hi-hat is a standard straight hi-hat. With the rear hi-hat would be setup in the remote hi-hat format. Optionally, both hi-hats could be setup as remote hi-hats.

The assembly of all the items into a kit makes the installation simple and easy for the user because the parts necessary to for a percussionist to use the instant invention is contained in the kit which includes a dual hi-hat Single Pedal, a hi-hat stand with actuator and a remote actuator for use with the heel pedal. This allows the musician to easily assemble and use the instant invention.

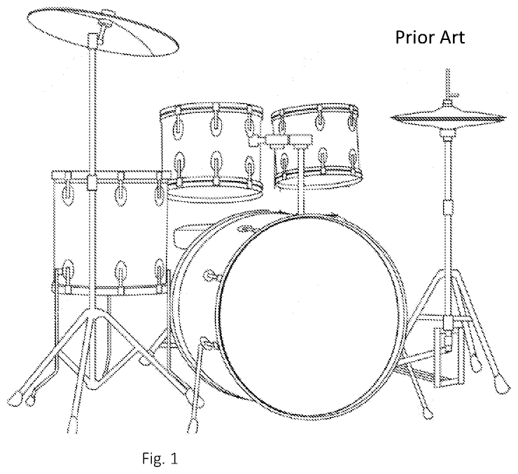

Referring now to the drawings FIGS. 1-9C, and more particularly to FIG. 1, there is shown a view of the prior art consisting of a drum set 300 with one hi-hat actuator and cymbal 301.

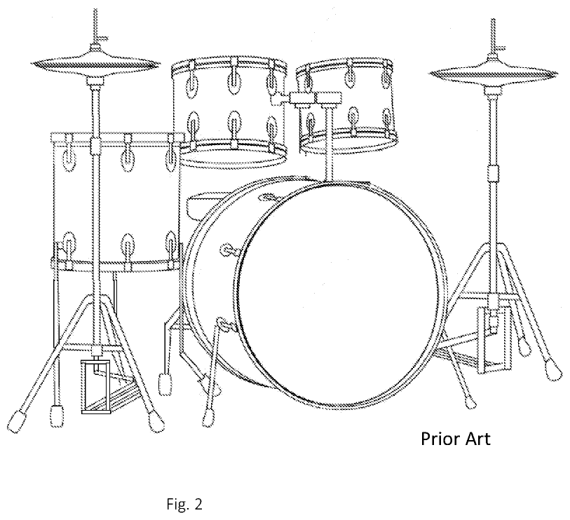

FIG. 2 is a view of the prior art consisting of a drum set 300 with first hi-hat actuator and cymbal 301 and second hi-hat cymbal 302.

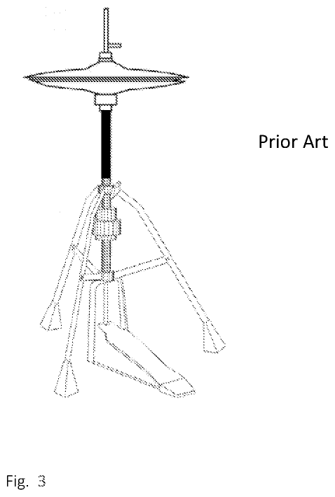

FIG. 3 is a view of the prior art with a single pedal hi-hat actuator and cymbal 303.

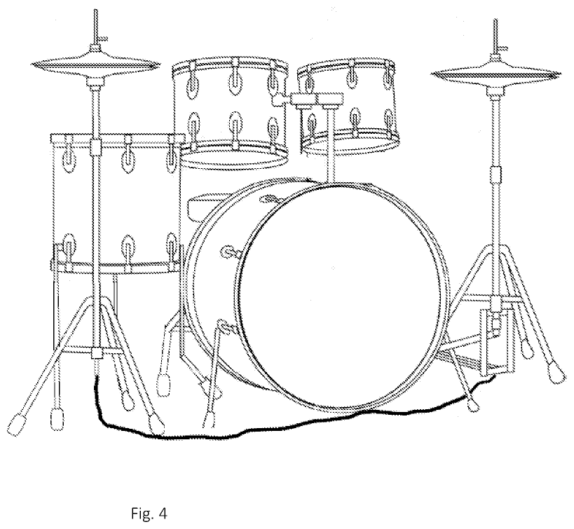

FIG. 4 is a view of a dual pedal hi-hat actuator with a first cymbal 305 and a second cymbal 306 operated by the dual pedal hi-hat actuator 310.

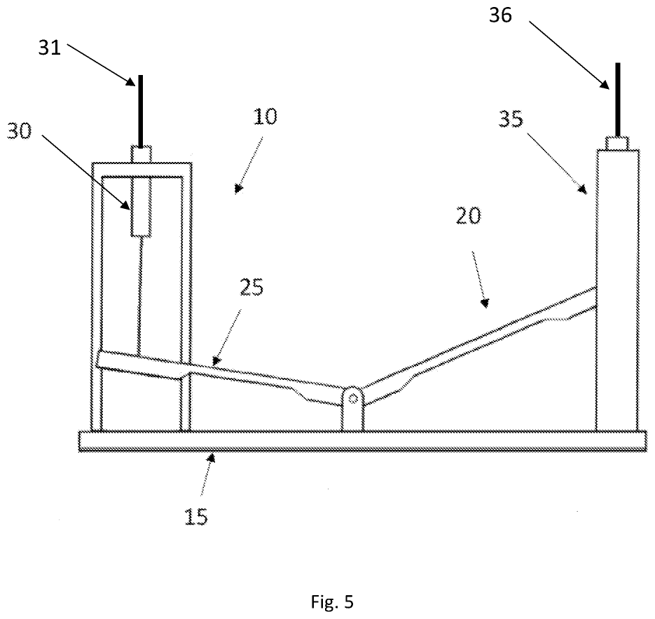

FIG. 5 shows a side view of the instant invention single pedal hi-hat actuator and cymbal 10. The front pedal and the rear pedal are in the open or up position. That is the standard position for a hi-hat pedal. Both pedals are attached to the base plate. In addition, one can see the hi-hat base for both the toe and heel pedal. Preferably the petal base plate 15, toe pedal 20, heel petal 25 are cast from a durable material such as stainless steel, steel or aluminum. However, a suitably manufactured plastic or 3-D printed parts can also be used. The exaggerated line at the foot of the base is to represent the padded attached to the bottom to the base plate. While FIG. 5 represents how the pedal looks in a in the current embodiment and therefore FIG. 5 and other figures only represent one possible embodiment of the instant invention.

The dual hi-hat single pedal assembly 10, is comprised of the petal base plate 15, toe pedal 20, heel petal 25, second hi-hat actuator 30 using connection 31 and first hi-hat actuator 35 using connection 36. The toe pedal 20 is operably attached to a first hi-hat cymbal using first hi-hat actuator 35 a traditional activation mechanism or a hydraulic actuator to raise and lower the cymbals using connection 36 and heel 25 is operably attached to a second hi-hat cymbal using second hi-hat actuator 30 that is alternatively a traditional mechanical activation mechanism or a hydraulic actuator that can allow the heel to operate a remote or distal hi-hat cymbal to raise and lower the cymbals using connection 31. The hydraulic activation system consists of the heel pedal 25 being operably connected to a first hydraulic activator such as a first hydraulic piston and the first hydraulic piston is hydraulic connected to a second hydraulic activator such as a second hydraulic piston and the second hydraulic cylinder operates the hi-hat cymbal such that they open and close as the heel pedal 25 is operated.

The following figures describe the three pieces that construct the actual pedal. This application provides a three-piece embodiment however the instant invention envisions many different constructs for the hi-hat dual pedal actuator. Therefore, the current embodiment comprises of three pieces that is a construct just one embodiment of the pedal. The dual pedal could also use a 3-D printed pedal combination of a front and rear pedal with either a real or virtual hinge.

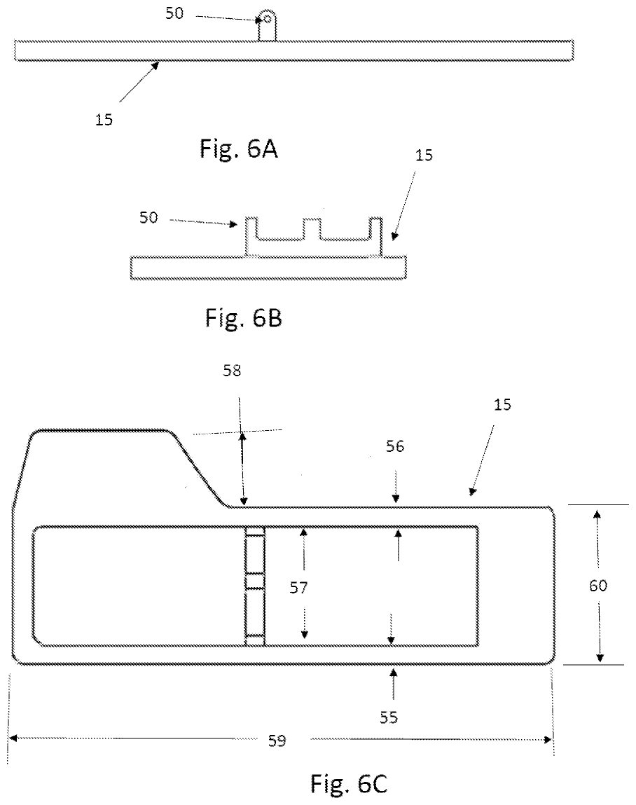

Referring to FIG. 6A, FIG. 6B and FIG. 6C, there is shown the three orthogonal views of the petal base plate 15. FIG. 6A is the right-side view petal base plate 15, FIG. 6B is an end view petal base plate 15 and FIG. 6C is a plan view petal base plate 15.

FIG. 6A shows a side view of the hinge connection point 50 of petal base plate 15. The instant invention envisions using a showing that the part can is approximately 0.5 inches thick, and the hinge pivot is approximately 1.0 inches high. However, any suitable dimensions can be used. The part can be made from a casting or any other method that can produce a strong and part such as 3-D printing. FIG. 6A is approximately 14 inches in length, and 0.5 inches in thick.

FIG. 6B shows the end view of petal base plate 15 from the heel section showing the hinge connection design. FIG. 6B shows that the petal base plate 15 is approximately 3.0-inch wide, and the hinge pivot is approximately 1.0 inches high above the base plate. However, any suitable dimensions can be used.

FIG. 6C shows a plan view of the petal base plate 15 current embodiment. The petal base plate 15 provides the hinge and in the current embodiment has an overall height of 1.5 inches The current embodiment has the following overall dimensions. Element 55 is approximately 0.375-inch. Element 57 is approximately 2⅝ inches across and forms a pocket in petal base plate 15, Element 56 is approximately 0.375 inches and element 58 is approximately 1 inch. Element 59 is approximately 14 inches and element 60 is approximately 3 inches.

The hi-hat placement for the heel pedal 25 has an open space underneath the heel pedal an area which is 3 inches wide×5.5 inches in length. There is no reason for the plate to be completely solid, however the instant invention can have a solid heel pedal. Within the industry because musicians normal transport their equipment from one location to another there is a need to reduce gross weight wherever possible and designing the various components, so they are light and strong is a customary practice. The petal base plate 15 as envisioned with the current embodiment is approximately 0.5 inches thick. Item 3 is the hinge connector which separates the petals with a 0.5-inch gap. These two areas preferable do not have any material. Item 4 is a 2 inch by 4-inch area for the toe pedal hi-hat connection.

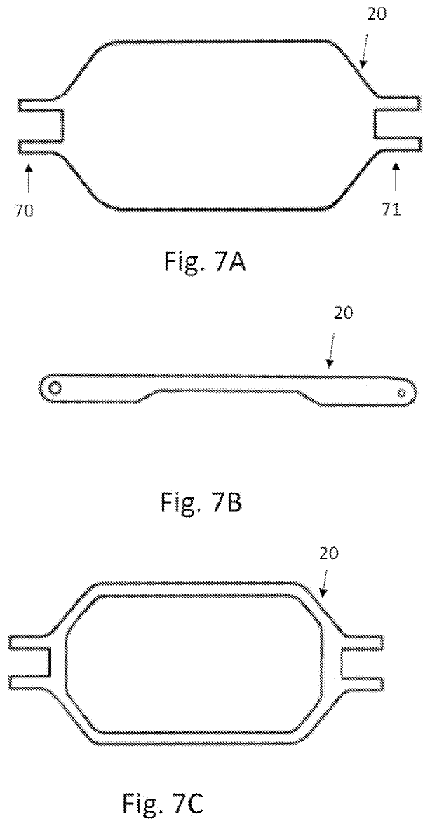

Referring to FIG. 7A shows the orthogonal views for the toe pedal 20. FIG. 7A, shows the hi-hat connection 70 which is 2.25 inches by 0.625-inch extension with a 0.5-inch separation. As shown the active side of the toe pedal that has a 3-inch width by 7-inch length. The hinge connection 71 is 2.25 inch by 0.75 extension with a 0.625-inch separation. The hinge is approximately at the mid-section is at least 0.25 inches wide or one half the depth.

The ridge that forms the outer portion of the pedal is approximately 0.25-inch in width and the plate center portion is approximately 0.125 thick.

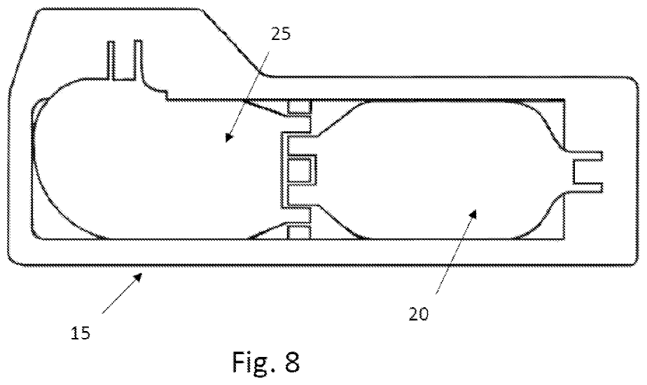

Referring to FIG. 8 is an overhead look at how the 3 pieces look when put together. Both petals work independently from the hinge. The performer can play either hi-hat simply by pressing down the ball of the foot for the front hi-hat, or the heel of the foot for the rear hi-hat.

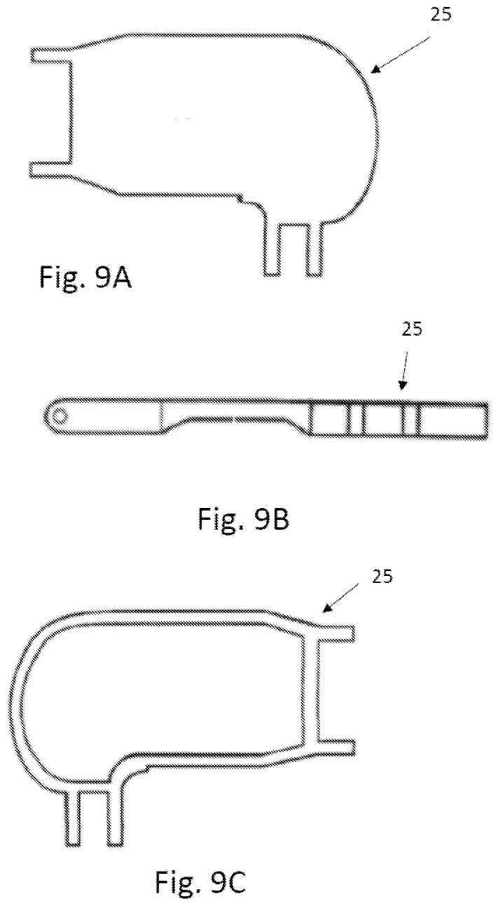

Referring to FIG. 9A-9C shows the orthogonal views for the heel pedal 25. FIG. 9A shows the plan view of the heel pedal 25. There is a 0.5-inch offset and a 2.25 by 1 inch extension with a 0.5-inch separation. The active side of the heel pedal 25 is 4.5 inches wide and 6.5 inches long and the hinge connection is 2.25 by 0.75-inch extension with a 2.25-inch separation.

FIG. 9B item 1 mid-section side view and the thickness is 0.5 inches thick.

FIG. 9C View C shows a 0.25-inch perimeter that surrounds the bottom section of the pedal. The internal part of the bottom portion of the heel pedal 25 is 0.125″ thick and has a 0.25 perimeter around the outside of the heel pedal 25.

The system can alternatively be shipped as a kit which includes a dual hi-hat Single Pedal, a hi-hat stand with actuator and a remote actuator for use t=with the heel pedal. This allows the musician to easily assemble and use the instant invention.

The system is a pedal system for operating two hi-hat cymbals comprising of a toe pedal, a heel pedal and a pedal base and the toe pedal is operably configured to actuate a first hi-hat cymbal and the heel pedal is operably configured to actuate a second hi-hat cymbal.

The pedal system for operating two hi-hat cymbals is configured such that the toe petal is made of materials selected from the group consisting of stainless steel, steel and aluminum.

The pedal system for operating two hi-hat cymbals is configured such that the heel petal is made of materials selected from the group consisting of stainless steel, steel and aluminum.

The pedal system for operating two hi-hat cymbals is configured such that the petal base is made of materials selected from the group consisting of stainless steel, steel and aluminum.

The pedal system for operating two hi-hat cymbals is configured such that the heel pedal is attached to a hydraulic activation mechanism and the hydraulic activation mechanism operates a hi-hat cymbal.

The pedal system for operating two hi-hat cymbals is configured such that the heel pedal is attached to a mechanical activation mechanism and the hydraulic activation mechanism operates a hi-hat cymbal.

The pedal system for operating two hi-hat cymbals is configured such that the pedal system is part of a kit containing at least one hi-hat cymbal, one dual pedal actuator and a hydraulic hi-hat actuator.

The pedal system for operating two hi-hat cymbals is configured such that the pedal system is part of a kit containing at least one hi-hat cymbal, one dual pedal actuator and a mechanical hi-hat actuator.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A pedal system for operating two hi-hat cymbals comprising of a toe pedal, a heel pedal and a pedal base and said toe pedal is operably configured to actuate a first hi-hat cymbal and said heel pedal is operably configured to actuate a second hi-hat cymbal.

2. The pedal system for operating two hi-hat cymbals of claim 1 wherein the toe petal is made of materials selected from the group consisting of stainless steel, steel and aluminum.

3. The pedal system for operating two hi-hat cymbals of claim 1 wherein the heel petal is made of materials selected from the group consisting of stainless steel, steel and aluminum.

4. The pedal system for operating two hi-hat cymbals of claim 1 wherein the petal base is made of materials selected from the group consisting of stainless steel, steel and aluminum.

5. The pedal system for operating two hi-hat cymbals of claim 1 wherein said heel pedal is attached to a hydraulic activation mechanism and said hydraulic activation mechanism operates a hi-hat cymbal.

6. The pedal system for operating two hi-hat cymbals of claim 1 wherein said heel pedal is attached to a mechanical activation mechanism and said hydraulic activation mechanism operates a hi-hat cymbal.

7. The pedal system for operating two hi-hat cymbals of claim 1 wherein said pedal system is part of a kit containing at least one hi-hat cymbal, one dual pedal actuator and a hydraulic hi-hat actuator.

8. The pedal system for operating two hi-hat cymbals of claim 1 wherein said pedal system is part of a kit containing at least one hi-hat cymbal, one dual pedal actuator and a mechanical hi-hat actuator.
